(19) United States
(12) Patent Application Publication
(10) Pub. No.: US 2006/0041793 A1
(43) Pub. Date: Feb. 23, 2006

(54) System, method and software for enhanced raid rebuild

(75) Inventors: Jacob Cherian, Austin, TX (US); Rohit Chawla, Waco, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 10/920,000

(22) Filed: Aug. 17, 2004

(51) Int. Cl. G06F 11/00

(52) U.S. Cl. 714/47

(57) ABSTRACT

A system, method and software for enhancing a redundant array of independent disks (RAID) rebuild process are provided. In association with the RAID, one or more bit maps is maintained corresponding to one or more data blocks of the RAID. During input/output (I/O) operations directed to the RAID, the I/O operations are evaluated to determine whether an operation will modify a data block of the RAID. If a data block is to be modified by an I/O operation, the bit map is preferably marked to indicate which data blocks of the RAID are being modified. In the event of disk failure, the bit map may be referenced in association with a disk reconstruction process such that only those data block having been modified before disk failure are reconstructed and these data blocks having not been modified remain substantially free from reconstructive operations.

### TECHNICAL FIELD

The present disclosure relates generally to information handling systems and, more particularly, to data and storage management systems, methods and software.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To provide the data storage demanded by many modern organizations, information technology managers and network administrators often turn to one or more forms of RAID (redundant arrays of inexpensive/independent disks). Typically, the disk drive arrays of a RAID are governed by a RAID controller and associate software. In one aspect, a RAID may provide enhanced input/output (I/O) performance and reliability through the distribution and/or repetition of data across a logical grouping of disk drives.

The RAID controller and its software represents this grouping of disks, called a logical unit, to the information handling system like a single disk drive. In some implementations, a RAID disk controller may use one or more hot-spare disk drives to provide additional data protection to logical units having a redundant RAID level. In an instance where a disk drive that is part of a logical unit fails, a hot-spare disk drive may be used to replace the failed drive. In such an instance, the data of the failed drive may be rebuilt in the hot-spare disk drive using data from the other drives that are part of the logical unit. In this manner, the logical unit may be returned to its redundant state and the hot-spare disk drive becomes part of the logical unit. In addition, if revertible hot-spare disk drives are supported when the failed drive is replaced with an operational drive, contents of the hot-spare disk drive may be copied to a new drive. As a result, the hot-spare disk drive may be removed from its function as part of the logical unit and returned to a hot-spare disk drive status.

Along with the increase in data storage requirements of enterprises comes a corresponding increase in the size of disk drives and logical units created from disk drives using RAID controllers. As a result of these increase in data storage requirements and drive sizes, the process of rebuilding a RAID logical unit to a hot-spare disk drive and then returning the hot-spare disk drive to its hot-spare status can take significant amounts of time. Such is especially true when there is concurrent I/O to the logical units from one or more host systems. The long time to rebuild a RAID logical unit to a hot-spare disk drive generally means that system must be operated in a degraded mode during which the system is exposed to data loss if a second drive in the logical unit fails, or if a media error occurs on one of the peer drives in the logical unit. In addition, the operations required to perform the rebuild and the build up of a replacement drive require resources from the RAID controller and can cause a reduction in overall performance.

### SUMMARY

In accordance with teachings of the present disclosure, a method for providing enhanced redundant array of independent disk (RAID) rebuilding is provided. In an exemplary embodiment, the method preferably includes accessing, in response to detection of a failed disk, a bit map corresponding to a plurality of data blocks of a RAID. The method preferably continues with determining, from the bit map, whether at least a first data block of the failed disk had been modified prior to disk failure and initiating reconstruction of each data block determined to have been modified prior to disk failure from data maintained in one or more operational disks of the RAID.

Further in accordance with embodiments of the present disclosure, software for facilitating the enhanced rebuilding of a redundant array of independent disks (RAID) is provided as part of the software of the RAID controller. In an exemplary embodiment, the software is embodied in computer readable media and when executed operable to direct a computer to identify one or more data blocks of a failed RAID disk having been modified prior to failure of the RAID disk and initiate reconstruction of the one or more modified data blocks of the failed disk onto a substitute disk, the reconstruction leveraging data maintained on one or more operational disks of the RAID.

Still further in accordance with teachings of the present disclosure, an information handling system, including a redundant array of inexpensive disks (RAID) and a controller operably associated with the RAID and operable to direct one or more activities in the RAID, the controller also having an associated memory is provided. The information handling system preferably also includes a program of instructions storable in a memory and executable by a processor and operable to cooperate with the RAID and the RAID controller and to initiate content reconstruction of one or more modified data blocks of a failed RAID disk on a substitute disk and such that data blocks of the substitute disk corresponding to unmodified data blocks of the failed disk are subjected to substantially no reconstructive operations.

In one aspect, teachings of the present disclosure provide a technical advantage in their ability to increase the efficiency with which a RAID logical unit may be rebuilt.

In another aspect, teachings of the present disclosure provide a technical advantage in their ability to monitor operations performed in a RAID system using minimal storage space.

In a further aspect, teachings of the present disclosure provide a technical advantage in their ability to reduce RAID system downtime by reducing unnecessary rebuild operations on data units of the RAID system not having experienced any modifying I/O operations.

In still another aspect, teachings of the present disclosure provide a technical advantage in their ability to increase RAID performance by reducing unnecessary rebuild operations on data units of the RAID system not having been subjected to any modifying I/O operations.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of an exemplary information handling system incorporating teachings of the present disclosure;

FIG. 2 is a flow diagram depicting an exemplary method for monitoring input/output operations and maintaining a modified data block bit map incorporating teachings of the present disclosure; and

FIG. 3 is a flow diagram depicting an exemplary method for reconstructing one or more failed disks in redundant array of inexpensive disks incorporating teachings of the present disclosure.

### DETAILED DESCRIPTION

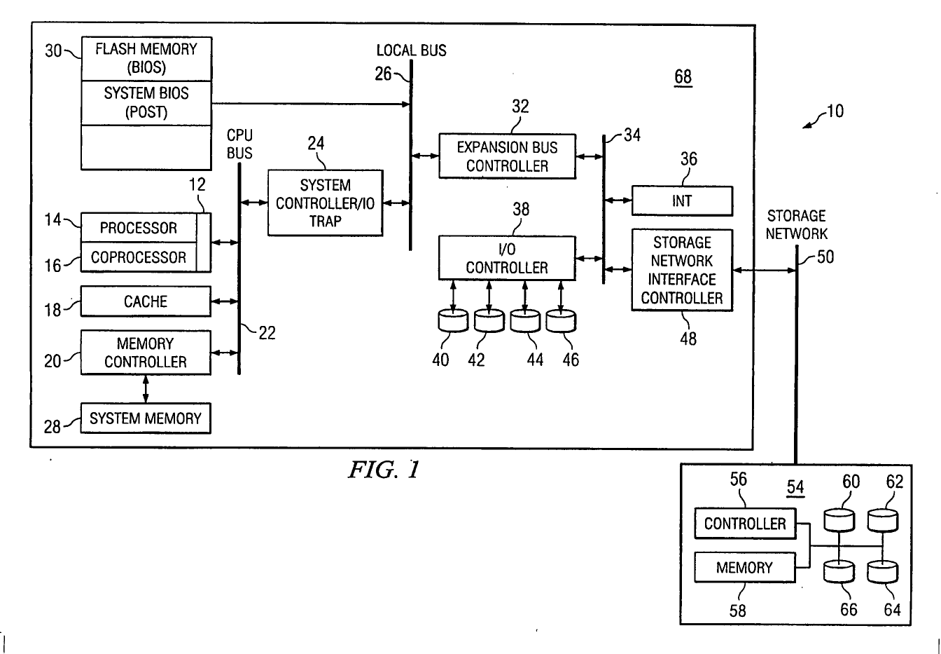

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring first to FIG. 1, a block diagram of an information handling system is shown according to teachings of the present disclosure. Information handling system 10 preferably includes at least one microprocessor or central processing unit (CPU) 12. CPU 12 may include processor 14 for handling integer operations and coprocessor 16 for handling floating point operations. CPU 12 is preferably coupled to cache 18 and memory controller 20 via CPU bus 22. System controller I/O (input/output) trap 24 preferably couples CPU bus 22 to local bus 26 and may be generally characterized as part of a system controller. Main memory 28 of dynamic random access memory (DRAM) modules is preferably coupled to CPU bus 22 by a memory controller 20.

Basic input/output system (BIOS) memory 30 is also preferably coupled to local bus 26. FLASH memory or other nonvolatile memory may be used as BIOS memory 30. A BIOS program (not expressly shown) is typically stored in BIOS memory 30. The BIOS program preferably includes software which facilitates initialization of information handling system 10 devices such as a keyboard (not expressly shown), a mouse (not expressly shown), or other devices as well as aids in the initial loading of the operating system.

Bus interface controller or expansion bus controller 32 preferably couples local bus 26 to expansion bus 34. Expansion bus 34 may be configured as an Industry Standard Architecture (“ISA”) bus or a Peripheral Component Interconnect (“PCI”) bus. Other information handling system configurations may include alternative expansion bus technologies.

Interrupt request generator 36 is also preferably coupled to expansion bus 34. Interrupt request generator 36 is preferably operable to issue an interrupt service request over a predetermined interrupt request line in response to receipt of a request to issue interrupt instruction from CPU 12.

I/O controller 38 is also preferably coupled to expansion bus 34. I/O controller 38 may also interface with hard drives 40, 42, 44 and 46. In an embodiment of teachings of the present disclosure, hard drives 40, 42, 44 and 46 may be configured as a redundant array of independent disks (RAID). Additional detail regarding RAID deployment and use is discussed in below.

Storage network interface controller 48 is preferably provided and enables information handling system 10 to communicate with a storage network 50, e.g., a Fibre Channel network. Storage network interface controller 48 preferably forms a network interface for communicating with an external RAID devices.

In addition to or in lieu of operating hard drive devices 40, 42, 44 and 46 in a RAID configuration, RAID device 54 may also be provided in association with information handling system 10. As illustrated in FIG. 1, RAID device 54 may be provided coupled to network 50. RAID device 54 may be provided coupled to a storage area network (SAN) or other network configuration.

As illustrated in FIG. 1, RAID device 54 may included one or more RAID controllers 56, RAID controller memory 58 and disk drives 60, 62, 64 and 66 configured as redundant array of inexpensive disks logical unit. RAID may be defined as a method of storing the same data in different places (thus, redundantly) on multiple hard disks. By placing data on multiple disks, I/O operations can overlap in a balanced way, improving performance.

A RAID typically appears to the operating system as a single logical unit or hard disk. Most RAID data storage methodologies employ the technique of striping, which involves partitioning each drive's storage space into data blocks or units ranging from a sector (512 bytes) up to several megabytes. The stripes of all the disks are interleaved and addressed in order.

Many existing RAID rebuild mechanism are available which can reconstruct a failing or failed disk to a hot-spare or replacement disk in their entirety. However, reconstructing an entire failed disk is not always necessary and, as such, existing RAID reconstructive utilities are wanting in at least their efficiency. Teachings of the present disclosure overcome many of the shortcomings of existing RAID reconstruction or rebuild utilities without sacrificing reliability or data integrity.

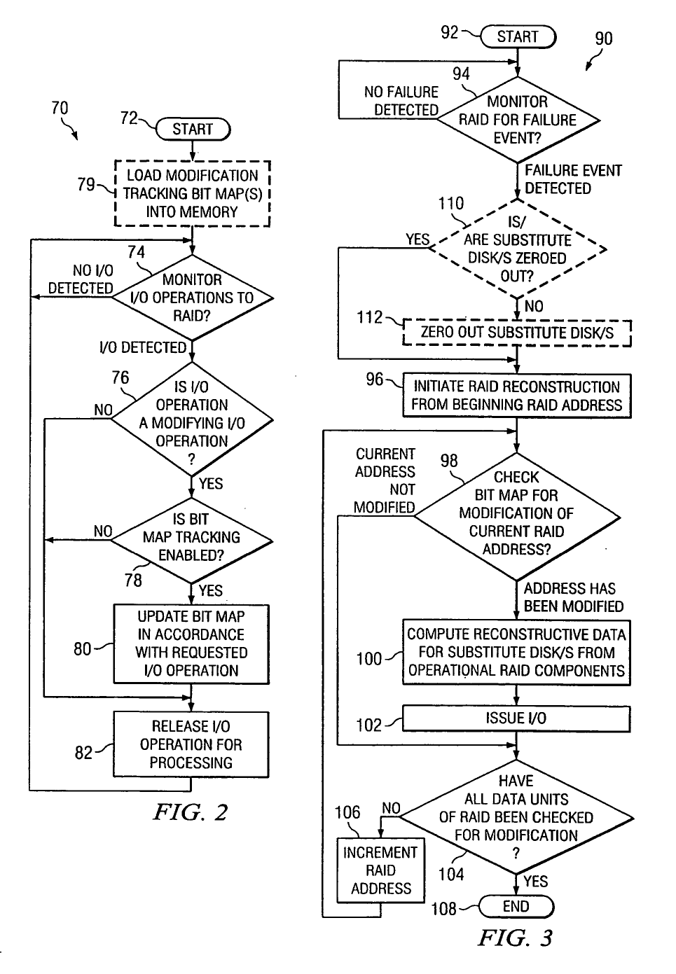

Referring now to FIG. 2, a flow diagram depicting an exemplary method for monitoring input/output operations in the RAID controller and maintaining a modified data block bit map incorporating teachings of the present disclosure is shown. According to teachings of the present disclosure, there are many instances of RAID usage where one or more data block or units dividing the storage space of the RAID go unutilized between the time a RAID is launched and when the RAID experiences a failure. In such circumstances, conventional RAID reconstruction utilities rebuild the failed or failing disk by reconstructing the entire failed or failing disk onto a hot-spare, replacement or other substitute disk drive. To overcome the efficiency problems evident in reconstructing vacant data blocks of a failed disk drive, teachings of the present disclosure provide a manner in which only those data blocks of a failed or failing disk that have been modified during usage of the RAID are reconstructed in response to a RAID failure event.

Method 70 of FIG. 2 preferably begins at 72 and thereafter preferably proceeds to 74. At 74, method 70 preferably begins monitoring operations between a host system, such as information handling system 68 of FIG. 1, and a RAID system, such as RAID 54 of FIG. 2. Preferably, the operations preferably performed at 74 include monitoring transactions to identify I/O operations directed to an associated RAID system. Method 70 preferably remains at 74 until an I/O operation directed to an associated RAID system is detected. Upon detection of an I/O operation directed to an associated RAID system, method 70 preferably proceeds to 76.

At 76, the detected I/O operation is preferably evaluated to determine whether the I/O operation will modify one or more aspects of the associated RAID system. For example, I/O operations seeking to write data to the associated RAID system may be considered modifying I/O operations. There may be additional I/O operations considered to be modifying operations.

If at 76 a detected I/O operation is determined to be an I/O operation seeking to modify one or more aspects of the associated RAID system, method 70 preferably proceeds to 78. At 78, method 70 preferably determines whether bit map tracking is enabled for the RAID system targeted by the modifying I/O operation.

If at 78 it is determined that bit map tracking is enabled for the RAID system targeted by the modifying I/O operation, method 70 preferably proceeds to 80. At 80, a bit map corresponding to the disk, data block and/or RAID stripe of the specific RAID targeted by the modifying I/O operation is marked, noted or otherwise altered to reflect that the targeted disk is to be modified.

A bit map to track modified data blocks or other units of a RAID system may be effected using a variety of methods. A bit map may include a bit to represent each strip on a disk of the RAID system. Alternatively, each bit of a bit map may be used to represent a complete stripe in the logical unit of the RAID.

Alternative bit map implementations may be used to manage disk space usage or for other purposes. For example, one embodiment of the present disclosure may employ a separate bit map for each disk drive of a particular RAID system. In an alternate embodiment, a single bit map may be employed which tracks those data blocks of all drives in a RAID system that have been modified. Further, the precise form of a bit map may be selected from many differing forms.

In general, the space availability requirements for a bit map for a logical unit may be defined by, for RAID-5 or RAID-3, as k/((n−1)*s*b) bytes, where ‘k’ is the size of the logical unit in bytes, ‘n’ is the number of drives and ‘s’ is the stripe size in bytes, and ‘b’ is the number of bits in a byte. For a RAID-1 implementation, the space availability requirement for a bit map may be generally defined by k/(s*b) bytes where ‘k’ is the size of the logical unit in bytes, ‘s’ is the stripe size in bytes, ‘b’ is the number of bits in a byte and where ‘n’, the number of drives, will always equal two (2). Similar formulas can be created for other redundant RAID levels to calculate the size of data that needs to be transferred. This disclosure does not preclude other redundant RAID levels.

In one implementation of teachings of the present invention, the bit map or bit maps designed to track modifications to the data blocks of a RAID system may be maintained in a space typically reserved by a RAID controller to store RAID configuration information. Alternatively or in addition, an additional memory, such as a non-volatile random access memory or a battery back-up memory may also maintain a bit map or back-up bit map copy. To further enhance bit map usage, each bit map may be flushed to a non-volatile memory or other storage area to help ensure availability of a current bit map when RAID reconstruction is desired.

Following a bit map update at 80, the determination that an I/O operation is not a modifying I/O operation at 76 or that bit map tracking is not enabled for the targeted RAID at 78, method 70 preferably proceeds to 82. At 82, the I/O operation may be released for processing. In this manner, marking the bit map before execution of a modifying operation, reduces the likelihood of a bit map associated with a logical unit or RAID system having stale or outdated data indicating those data blocks or units having been modified. In addition, this manner of updating a RAID unit modification tracking bit map may also reduce any performance impact associated with the modification tracking. Following release of the I/O operation at 82, method 70 preferably returns to 74 where the next RAID related I/O operation may be awaited.

Referring now to FIG. 3, a flow diagram depicting an exemplary method for reconstructing one or more failed disks in a redundant array of inexpensive disks incorporating teachings of the present disclosure is shown. In cooperation, methods 70 and 90 may enable the tracking of modified data units in a RAID system and the efficient reconstruction of one or more failed or failing disks with at least a portion of the enhanced efficiency flowing from the present disclosure's ability to minimize reconstructive operations associated with unmodified data blocks or units of the failed or failing components.

Upon initiation at 92, method 90 preferably proceeds to 94 where the RAID system may be monitored for its integrity. In particular, method 90 may provide for monitoring RAID component operability such as whether one or more independent disks has failed or is failing. The manner in which RAID components may be monitored is variable and teachings of the present disclosure are not intended to be limited to a particular RAID monitoring implementation.

If at 94 there is no RAID operability issue detected by the selected RAID monitoring implementation, method 90 preferably remains at 94, substantially continuously monitoring RAID integrity. However, if at 94 it is detected that one or more RAID components has failed or are failing, method 90 preferably proceeds to 96.

At 96, method 90 preferably provides for beginning reconstructive operations for the one or more failed or failing RAID components. In an exemplary implementation of teachings of the present disclosure, reconstructive or rebuild activities are preferably initiated at the first address of the RAID, such as LBA (logical block address) zero (0). In one aspect, the address at which reconstruction preferably begins may serve as a counter or pointer for the operations that preferably follow, as discussed below. Following initiation of RAID reconstruction or rebuild at 96, preferably at LBA zero or the first address of the RAID, method 90 preferably proceeds to 98.

At 98, the one or more bit maps maintained by the system to track those units or data blocks of the RAID having been modified and the current RAID address may be utilized to determine the activities that preferably follow. Specifically, beginning at LBA zero, method 90 preferably provides for a check of the one or more data block modification tracking bit maps to be accessed to determine whether the data block associated with the current address, LBA zero here, was modified prior to disk failure or initiation of reconstruction. If at 98 it is determined that the current RAID address had been modified prior to failure of an associated RAID component or initiation of the reconstructive process, method 90 preferably proceeds to 100.

At 100, method 90 preferably provides for content to be placed on a substitute disk designed to replace the failed or failing component to be generated. In one embodiment of RAID rebuild or reconstruction, the data to be placed on a substitute disk, whether the substitute disk is a temporary hot-spare disk or a replacement disk for the failed device, is preferably generated from data maintained by the remaining, operational disks of the RAID. Following computation of the content to be placed at the current address on the substitute disk, the reconstructed content is preferably written to the substitute disk at the current address, LBA zero in the current example, at 102.

Following reconstruction of the content associated with a modified data block at 100 and 102 or following a determination at 98 that the data block associated with the current address of the RAID had not been modified prior to failure detection or beginning reconstructive operations, method 90 preferably proceeds to 104. At 104, method 90 preferably makes a determination as to whether the RAID reconstructive or rebuild process has been completed. In particular, method 90 preferably determines at 104 whether any additional addresses, such as logical block addresses or their data block parameters, of the RAID remain for evaluation as to their status of having been modified prior to failure detection or the reconstructive process.

If at 104 it is determined that all addresses or logical block addresses of the RAID have been reconstructed or determined not need reconstruction, i.e., the data blocks associated with such addresses had not been modified prior to reconstruction initiation, method 90 preferably ends at 108. Alternatively, if at 104 it is determined that one or more data blocks or units of the RAID have yet to be evaluated for their reconstructive needs, method 90 preferably proceeds to 106 where the current address counter or pointer may be incremented before method 90 returns to 98 for additional operations.

In the iterations of method 90 that follow the exemplary processing generally described above, each data block of the RAID and failed RAID component will be checked to determine whether each had been modified prior to identification of a disk failure and, consequently, whether such data blocks need to be reconstructed. According to teachings of the present disclosure, inefficiencies in RAID rebuild often occur as a result of performing unneeded processing on data blocks of the RAID that have remained unmodified, such as in a zeroed out state. In general, if a data unit of the RAID was not modified prior to initiation of the reconstructive process, such data unit needn't be reconstructed.

In an effort to enhance the efficiencies taught in an exemplary embodiment of the present disclosure, method 90 may be modified to include evaluating whether a substitute disk is in a zeroed-out state 110 and, if not, zeroing out the substitute disk 112 prior to initiating the rebuilding or reconstructive process at 96. By ensuring the presence of a zeroed out hot-spare, replacement or other substitute disk, method 90 at 98 may skip substantially all processing with regards to those data blocks or units of the RAID indicated by the one or more data block modification tracking bit maps as having not been modified prior to disk failure or reconstruction. In this manner, following completion of method 90, all data blocks having been modified prior to disk failure or reconstruction are reconstructed from the operational disks of the RAID and all data blocks of the RAID having not been modified are already in a zeroed out state, ready for use in normal RAID operations.

Although the disclosed embodiments have been described in detail, it should be understood that various changes, substitutions and alterations can be made to the embodiments without departing from their spirit and scope.

What is claimed is:

1. A method for providing enhanced redundant array of independent disk (RAID) rebuilding, comprising:
accessing, in response to detection of a failed disk, a bit map corresponding to a plurality of data blocks of a RAID;
determining, from the bit map, whether at least a first data block of the failed disk had been modified prior to disk failure; and
initiating reconstruction of each data block determined to have been modified prior to disk failure from data maintained in one or more operational disks of the RAID.

2. The method of claim 1, further comprising repeating the accessing, determining and initiating operations until reconstruction has been initiated for each data block determined to have been modified such that only those data block having been previously modified are processed for reconstruction.

3. The method of claim 1, further comprising:
reviewing input/output (I/O) operations directed to one or more disks of the RAID;
identifying whether an I/O operation is a write operation;
in response to identification of a write operation, determining to which data block the write operation is directed; and
updating a portion of the bit map associated with the data block to which the write operation is directed.

4. The method of claim 3, further comprising updating the bit map prior to execution of the write operation.

5. The method of claim 1, further comprising loading the bit map into a RAID controller memory upon initiation of the RAID controller.

6. The method of claim 1, further comprising zeroing out a hot spare designated disk prior to making the hot spare disk available for reconstruction.

7. The method of claim 1, further comprising zeroing out a disk designated to replace the failed disk prior to initiating reconstruction of failed disk contents on the designated replacement disk.

8. The method of claim 1, further comprising maintaining a backup copy of the bit map in one or more non-volatile storage areas.

9. Software for facilitating the enhanced rebuilding of a redundant array of independent disks (RAID), the software embodied in computer readable media and when executed operable to direct a computer to:
identify one or more data blocks of a failed RAID disk having been modified prior to failure of the RAID disk; and
initiate reconstruction of the one or more modified data blocks of the failed disk onto a substitute disk, the reconstruction leveraging data maintained on one or more operational disks of the RAID.

10. The software of claim 9, further operable to:
review a bit map corresponding to a plurality of data blocks in the RAID; and
identify one or more modified data blocks of the RAID from information contained in the bit map.

11. The software of claim 9, further operable to:
analyze input/output operations submitted to the RAID; and
note, in a bit map corresponding to one or more data blocks of the RAID, when an I/O operation seeks to modify one or more of the data blocks of the RAID.

12. The software of claim 9, further operable to load a bit map corresponding to one or more data blocks of a RAID into a RAID controller memory upon initiation of the RAID controller.

13. The software of claim 9, further operable to maintain a backup copy of a bit map corresponding to one or more data blocks of the RAID in a non-volatile storage area.

14. The software of claim 9, further operable to:
verify that a substitute disk provided to replace a failed disk is zeroed out; and
in response to a determination that the substitute disk is not zeroed out zeroing out the substitute disk prior to initiation of data block reconstruction.

15. An information handling system, comprising:
a redundant array of inexpensive disks (RAID);
a controller operably associated with the RAID and operable to direct one or more activities in the RAID, the controller having an associated memory; and
a program of instructions storable in a memory and executable by a processor, the program of instructions operable to cooperate with the RAID and the RAID controller and to initiate content reconstruction of one or more modified data blocks of a failed RAID disk on a substitute disk and such that data blocks of the substitute disk corresponding to unmodified data blocks of the failed disk are subjected to substantially no reconstructive operations.

16. The information handling system of claim 15, further comprising the program of instructions operable to access a bit map corresponding to one or more data blocks of the failed disk to identify at least one data block modified prior to disk failure, the bit map including information indicating whether a data block of the failed drive has been previously modified.

17. The information handling system of claim 16, further comprising the program of instructions operable to load one or more bit maps into the RAID controller memory upon initiation of the RAID controller.

18. The information handling system of claim 16, further comprising the program of instructions operable to backup the bit map at one or more selected intervals.

19. The information handling system of claim 15, further comprising the program of instructions operable to determine whether an input/output (I/O) operation directed to the RAID is a modifying operation and, in response to a modifying operation determination, update at least a portion of a bit map representing the data block at which the modifying I/O operation is directed.

20. The information handling system of claim 15, further comprising:
a substitute disk; and
the program of instructions operable to zero out the substitute disk prior to making the substitute disk available for RAID reconstruction.

21. The information handling system of claim 15, further comprising a battery backup enabled memory operably associated with the RAID and operable to maintain a bit map representing at least one modified data block of the RAID.

22. The information handling system of claim 15, further comprising the program of instructions operable to maintain a bit map corresponding to the data blocks of each disk included in the RAID, the bit map including information indicative of at least one modified data block of an associated disk.

23. The information handling system of claim 15, further comprising the program of instructions operable to maintain a single bit map representing data blocks of the RAID and operable to maintain data indicating whether a data block has been modified.
